(19) United States
(12) Patent Application Publication
(10) Pub. No.: US 2008/0267264 A1
(43) Pub. Date: Oct. 30, 2008

(54) Low phase noise clock generator for device under test

(76) Inventor: Timothy F. Scranton, Rancho Santa Margarita, CA (US)

Correspondence Address: FARJAMI & FARJAMI LLP, 26522 LA ALAMEDA AVENUE, SUITE 360, MISSION VIEJO, CA, 92691, US

(21) Appl. No.: 11/796,590

(22) Filed: Apr. 26, 2007

(51) Int. Cl. H04B 1/00

(52) U.S. Cl. 375/149; 375/E01.001

(57) ABSTRACT

According to one embodiment, a low phase noise clock generator includes a frequency multiplier using a crystal oscillator, which is configured to receive a reference clock and to generate a multiplied reference clock. The low phase noise clock generator further includes a prescaler module configured to divide down a frequency and significantly reduce phase noise of the multiplied reference clock to generate a low phase noise clock. In one embodiment, a tester can be configured to input the low phase noise clock into the crystal oscillator input of a device under test to accurately test a phase noise of the device under test.

### BACKGROUND OF THE INVENTION

1. Field of the Invention

The present invention is generally in the field of electronics. More particularly, the present invention is in the field of electronic device testing.

2. Background

Manufacturers of electronic devices generally rely on high volume testers, e.g. automated test equipment (“ATE”), to quickly and accurately test their electronic devices during production. Accordingly, the testers are configured to drive the electronic devices by generating and inputting various signals, e.g., a reference clock, into the electronic devices to test and evaluate their functionality. It is important for the signals generated by the testers to have similar characteristics as the actual signals used by the electronic devices during normal operation. For example, it is important for clock signals provided by a tester to have a phase noise as low as clock signals generated with the aid of a crystal oscillator employed during normal operation of an electronic device.

In particular, when testing an electronic device, such as a wireless local area network (“WLAN”) transceiver, it is critical for a tester to generate a reference clock having a phase noise that is as low as the phase noise of the clock used by the electronic device during normal operation. Since a conventional tester typically generates a reference clock using a conventional reference clock generator (e.g. a dedicated reference signal generator or a stand-alone function generator), the reference clock from the conventional tester typically has a much higher phase noise than the phase noise of the clock generated by the electronic device during normal operation. Consequently, various electronic devices, such as WLAN transceivers, cannot be accurately tested using conventional testers.

### SUMMARY OF THE INVENTION

A low phase noise clock generator for device under test, substantially as shown in and/or described in connection with at least one of the figures, as set forth more completely in the claims.

### BRIEF DESCRIPTION OF THE DRAWINGS

FIG. 1 shows a block diagram of a conventional testing system.

FIG. 2 shows a block diagram of a low phase noise testing system in accordance with one embodiment of the invention.

FIG. 3 shows a block diagram of a low phase noise clock generator in accordance with one embodiment of the present invention.

### DETAILED DESCRIPTION OF THE INVENTION

The present invention is directed to a low phase noise clock generator for device under test. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention.

The drawings in the present application and their accompanying detailed description are directed to merely exemplary embodiments of the invention. To maintain brevity, other embodiments of the present invention are not specifically described in the present application and are not specifically illustrated by the present drawings.

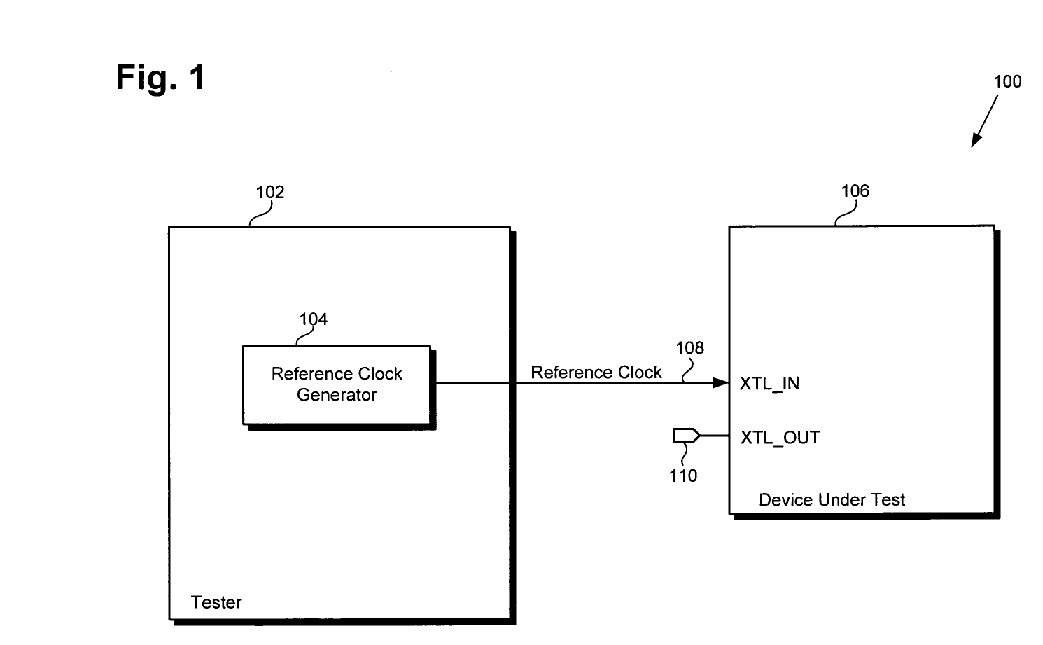

FIG. 1 shows a block diagram of a conventional testing system. System 100 includes conventional tester 102 and device under test 106. As shown in FIG. 1, tester 102 includes conventional reference clock generator 104, which is configured to generate reference clock 108. Reference clock generator 104 can be, for example, a dedicated reference signal generator or a stand-alone function generator situated in tester 102 and reference clock 108 can be, for example, a time varying sinusoidal signal. Device under test 106 can be, for example, an electronic device such as a wireless local area network (“WLAN”) transceiver or a Worldwide Interoperability for Microwave Access (“WiMAX”) transceiver. In the embodiment shown in FIG. 1, reference clock 108 is input to the crystal oscillator input (“XTL_IN”) of device under test 106, while crystal oscillator output (“XTL_OUT”) 110 is left floating. It should be noted that tester 102 might be coupled to device under test 106 with a number of buses and probes during actual testing of device under test 106, which are not shown in FIG. 1.

By way of background, proper testing of electronic devices operating at high frequencies, such as WLAN and WiMAX transceivers, generally involves an accurate measurement of the phase noise of the electronic devices. These electronic devices typically utilize a crystal oscillator during normal operation to generate a clock having very low phase noise. However, such a crystal oscillator cannot be used in device under test 106 during testing because, for example, tester 102 requires coherency with the reference clock of device under test 106. Since reference clock 108 generated by conventional reference clock generator 104 has a substantially higher phase noise than the phase noise of a reference clock generated by a crystal oscillator, tester 102 cannot accurately test the phase noise of device under test 106.

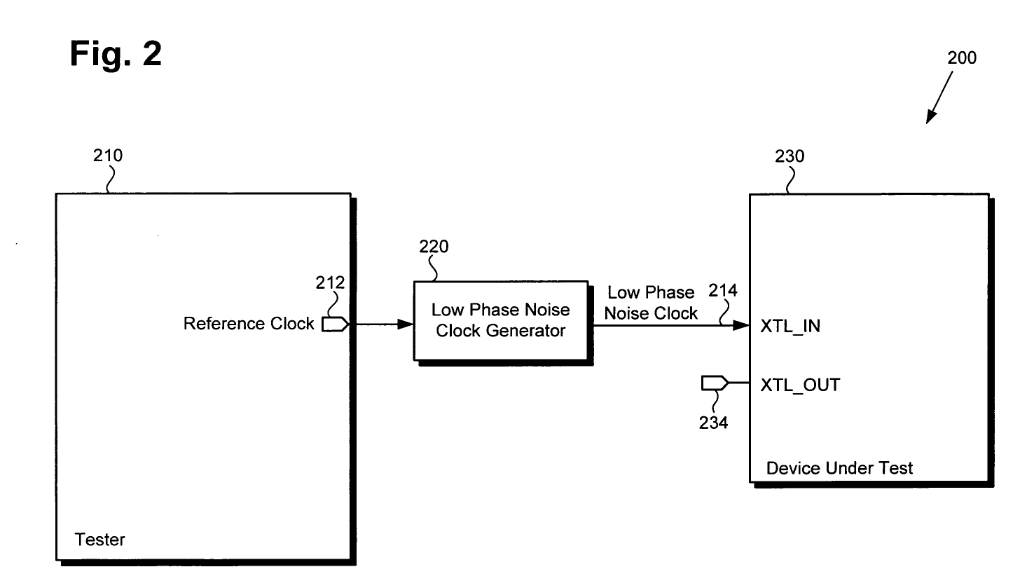

FIG. 2 shows a block diagram of a low phase noise testing system in accordance with one embodiment of the invention. System 200 includes tester 210, low phase noise clock generator 220, and device under test 230. As shown in FIG. 2, tester 210 can provide reference clock 212 to low phase noise clock generator 220. Reference clock 212 can be, for example, a time varying signal, such as a sinusoidal signal. In one embodiment, reference clock 212 can be a reference clock generated by a dedicated reference signal generator or a stand-alone function generator. In another embodiment, reference clock 212 can be a reference clock generally available in tester 210.

As also shown in FIG. 2, low phase noise clock generator 220 can be configured to generate low phase noise clock 214, which can be provided to the crystal oscillator input (“XTL_IN”) of device under test 230. In the embodiment shown in FIG. 2, crystal oscillator output (“XTL_OUT”) 234 of device under test 230 is left floating. Device under test 230 can be, for example, a wireless chip such as a WLAN transceiver, a WiMAX transceiver, or a Bluetooth transceiver. It should be noted that tester 210 can be coupled to device under test 230 with a number of buses and probes during actual testing of device under test 230, which are not shown in FIG. 2 to avoid obscuring the invention.

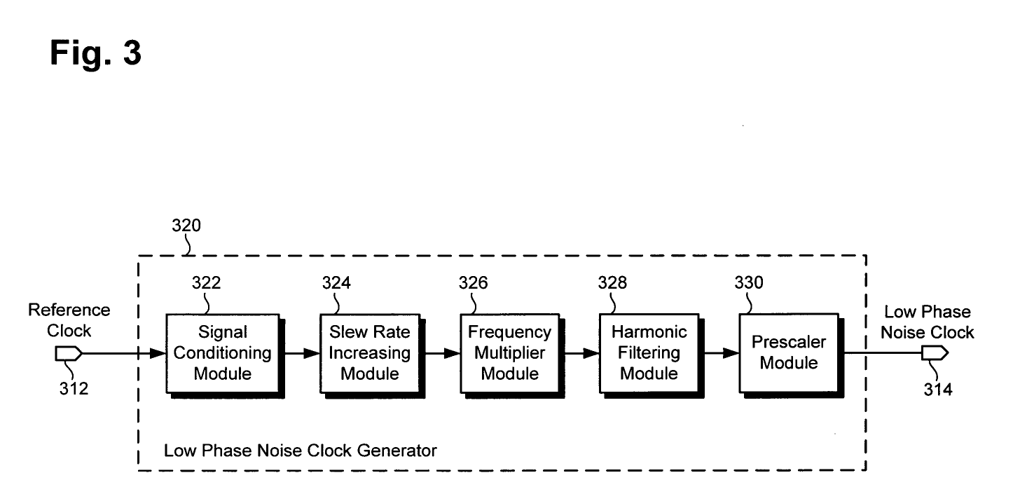

The operation of low phase noise clock generator 220 in FIG. 2 will now be discussed with reference to both FIGS. 2 and 3. FIG. 3 shows a block diagram of a low phase noise clock generator in accordance with one embodiment of the present invention. As shown in FIG. 3, low phase noise clock generator 320 includes signal conditioning module 322, slew rate increasing module 324, frequency multiplier module 326, harmonic filtering module 328, and prescaler module 330. As shown in FIG. 3, low phase noise reference clock generator 320 is configured to receive reference clock 312 and to output low phase noise clock 314. In one embodiment, reference clock 312, low phase noise clock generator 320, and low phase noise clock 314 in FIG. 3 correspond to reference clock 212, low phase noise clock generator 220, and low phase noise clock 214 in FIG. 2, respectively.

As shown in FIG. 3, signal conditioning module 322 can be configured to receive reference clock 312. In one embodiment, signal conditioning module 322 can include various passive and active electronic components configured to provide proper coupling between the tester (i.e., tester 210 in FIG. 2) and low phase noise clock generator 320, and to adjust the direct current (“DC”) level of reference clock 312. For example, signal conditioning module 322 can include a termination resistor having a resistance of, for example, approximately 50 ohms for achieving an appropriate input impedance. Signal conditioning module 322 can further include, for example, a DC blocking capacitor and a voltage divider to adjust the DC level of reference clock 312 to a suitable DC level.

As shown in FIG. 3, slew rate increasing module 324 is coupled to signal conditioning module 322. In one embodiment, slew rate increasing module 324 can include a configuration of one or more logic gates. For example, slew rate increasing module 324 can include a NAND gate configured to function as an inverter. Accordingly, the NAND gate can significantly increase the slopes of the rising and falling edges of reference clock 312 to optimize the performance of frequency multiplier module 326 discussed below. In another embodiment, slew rate increasing module 324 can include various passive and active components configured to increase the slew rate of reference clock 312 using techniques known in the art.

As further shown in FIG. 3, frequency multiplier module 326 is coupled to slew rate increasing module 324. In one embodiment, frequency multiplier module 326 can include a circuit configured to receive and to multiply reference clock 312 using a reference frequency generated by a crystal oscillator. For example, frequency multiplier module 326 can include a phase-locked loop (“PLL”) circuit configured as a frequency multiplier, which uses a reference frequency generated by a voltage controlled crystal oscillator (“VCXO”). In one embodiment, frequency multiplier module 326 can be a frequency controlled crystal oscillator (“FCXO”) known in the art.

Thus, frequency multiplier module 326 can be configured to output a “multiplied reference clock” that is an integer (or non-integer) multiple of reference clock 312. For example, frequency multiplier module 326 can be configured to receive a reference clock having a frequency of approximately 20 megahertz (“MHz”) and to generate a multiplied reference clock having a frequency which is greater by a factor of ten (i.e., a frequency of approximately 200 MHz). It is important to note that since frequency multiplier module 326 uses a crystal oscillator to generate the multiplied reference clock, the multiplied reference clock of the invention has significantly lower phase noise than a reference clock of equal frequency generated by a conventional reference clock generator. For example, the phase noise of a 200 MHz reference clock generated by a conventional reference clock generator can be as high as approximately −120 decibels relative to the carrier power per Hertz (dBc/Hz) at an offset of 10.0 kilohertz (“kHz”), whereas the phase noise of a 200 MHz “multiplied reference clock” generated by frequency multiplier module 326 can be approximately −140 dBc/Hz at an offset of 10.0 kHz.

As shown in FIG. 3, harmonic filtering module 328 is coupled to frequency multiplier module 326. In one embodiment, harmonic filtering module 328 can include an electronic filter configured to reject undesirable harmonics of the above-mentioned multiplied reference clock. The electronic filter can be, for example, a passive filter or an active filter. For example, the electronic filter can be a band-pass filter having a center frequency that is approximately equal to the frequency of the multiplied reference clock, and which is configured to adequately attenuate the second harmonic, and all higher harmonics, of the multiplied reference clock. For example, if the multiplied reference clock is configured to have a frequency of 200 MHz as in the example provided above, the center frequency of the band-pass filter can be 200 MHz with a rejection of at least 32 dB at a frequency of 400 MHz. In another example, the electronic filter can be a low-pass filter configured to reject the second harmonic, and all higher harmonics, of the multiplied reference clock. In general, harmonic filtering module 328 impedes or eliminates false triggering of prescaler module 330 that would otherwise be caused. In other words, in the absence of harmonic filtering module 328, undesirable harmonics of the multiplied reference clock outputted by frequency multiplier 326 would cause false triggering of prescaler module 330, which would result in an inaccurate count by prescaler module 300, in turn resulting in failure of low phase noise clock generator 320. Thus, one of ordinary skill in the art can appreciate that various implementations of the abovementioned electronic filters can be used in filtering module 328 without departing from the scope of the invention.

As shown in FIG. 3, prescaler module 330 is coupled to harmonic filtering module 328. In one embodiment, prescaler module 330 can include a circuit configured to divide down the multiplied reference clock, and thus proportionally reduce the phase noise of the multiplied reference clock, by a desired factor to generate low phase noise clock 314. For example, prescaler module 330 can be configured to divide down a multiplied reference clock having a frequency of approximately 200 MHz by a factor of ten to generate a low phase noise clock having a frequency of approximately 20 MHz. The phase noise of low phase noise clock 314 generated by prescaler module 330 can be determined by the equation:

PNₗₚₙ=PN_{mrf}−20*log(N) (equation 1)

where PNₗₚₙ is the phase noise of low phase noise clock 314 in decibels relative to the carrier power per Hertz (dBc/Hz), PN_{mrf} is the phase noise of the multiplied reference clock in dBc/Hz, and N is the factor used by prescaler module 330 in dividing down the multiplied reference clock.

Thus, with reference to equation 1, prescaler module 330 can be configured to divide down a multiplied reference clock by a factor “N” to generate a low phase noise reference clock having a phase noise which is 20*log(N) less than the phase noise of the multiplied reference clock. Therefore, in accordance with the example provided above, prescaler module 330 can be configured to divide down a 200 MHz multiplied reference clock having a phase noise of −140 dBc/Hz at an offset of 10 kHz by a factor of ten to generate a 20 MHz low phase noise reference clock having a phase noise of −160 dBc/Hz at an offset of 10 kHz. It is noted that it is important for prescaler module 330 to have a very low inherent phase noise so that prescaler module 330 does not introduce its own phase noise into output 314 of low phase noise clock generator 320.

Therefore, the present invention allows tester 210 to drive the crystal oscillator input of device under test 230 using low phase noise clock 214, which has a phase noise as low as or lower than a phase noise of a reference clock generated by a crystal oscillator. Furthermore, low phase noise clock generator 220 maintains coherency between reference clock 212 and low phase noise clock 214, without causing a slow down in the production test time due to, for example, digital signal processing that would otherwise be required to compensate for the lack of coherency. Thus, coherency is achieved and maintained, allowing the fastest possible production test times. As such, tester 210 can accurately test a phase noise of a high frequency electronic device, such as device under test 230. Since low phase noise clock generator 220 can receive a reference clock form a variety of sources including a reference clock generally available in tester 210 itself, the present invention can advantageously eliminate the need for costly dedicated reference signal generators or stand-alone function generators. Accordingly, and considering the low cost involved in implementing low phase noise clock generator 220, the present invention significantly increases the accuracy of tester 210, while reducing the overall cost of tester 210.

From the above description of the invention it is manifest that various techniques can be used for implementing the concepts of the present invention without departing from its scope. For example, although in the examples used in the present application the frequency of reference clock 312 is equal to the frequency of low phase noise clock 314 (both being 20 MHz), such equality is not at all required. In other words, a designer's choice of the multiplication factor of frequency multiplier module 326 and the division factor of prescaler module 330, can result in any frequency relationship between the frequencies of reference clock 312 and low phase noise clock 314 and, in general, these two frequencies are not equal. Moreover, while the invention has been described with specific reference to certain embodiments, a person of ordinary skill in the art would appreciate that changes can be made in form and detail without departing from the spirit and the scope of the invention. Thus, the described embodiments are to be considered in all respects as illustrative and not restrictive. It should also be understood that the invention is not limited to the particular embodiments described herein but is capable of many rearrangements, modifications, and substitutions without departing from the scope of the invention.

Thus, a low phase noise clock generator for device under test has been described.

1. A low phase noise clock generator comprising:
a frequency multiplier using a crystal oscillator and configured to receive a reference clock and to generate a multiplied reference clock;
a prescaler configured to divide down a frequency and phase noise of said multiplied reference clock to generate a low phase noise clock.

2. The low phase noise clock generator of claim 1 further comprising a harmonic filtering module configured to reject a harmonic of said multiplied reference clock.

3. The low phase noise clock generator of claim 1 further comprising a slew rate increasing module configured to increase a slew rate of said reference clock.

4. The low phase noise clock generator of claim 1 further comprising a signal conditioning module configured to adjust said reference clock.

5. The low phase noise clock generator of claim 1 wherein a frequency of said reference clock and a frequency of said low phase noise clock are approximately equal.

6. The low phase noise clock generator of claim 2 wherein said harmonic filtering module includes a band-pass filter.

7. The low phase noise clock generator of claim 3 wherein said slew rate increasing module includes at least one logic gate.

8. The low phase noise clock generator of claim 4 wherein said signal conditioning module includes a termination resistor, a DC blocking capacitor, and a voltage divider.

9. The low phase noise clock generator of claim 1 wherein said reference clock is generated by a tester.

10. A low phase noise testing system comprising:
a tester configured to generate a reference clock;
a low phase noise clock generator comprising a frequency multiplier using a crystal oscillator and configured to receive said reference clock and to generate a multiplied reference clock, and further comprising a prescaler configured to divide down a frequency and phase noise of said multiplied reference clock to generate a low phase noise clock.

11. The system of claim 10 wherein said low phase noise clock generator is coupled to and drives a device under test.

12. The system of claim 11 wherein said device under test is a wireless chip.

13. The system of claim 12 wherein said wireless chip is selected from the group consisting of a wireless local area network (“WLAN”) transceiver, a Worldwide Interoperability for Microwave Access (“WiMAX”) transceiver, and a Bluetooth transceiver.

14. The system of claim 10 wherein said low phase noise clock generator further comprises a harmonic filtering module configured to reject a harmonic of said multiplied reference clock.

15. The system of claim 10 wherein said low phase noise clock generator further comprises a slew rate increasing module configured to increase a slew rate of said reference clock.

16. The system of claim 10 wherein said low phase noise clock generator further comprises a signal conditioning module configured to adjust said reference clock.

17. The system of claim 10 wherein a frequency of said reference clock and a frequency of said low phase noise clock are approximately equal.

18. The system of claim 14 wherein said harmonic filtering module includes a band-pass filter.

19. The system of claim 15 wherein said slew rate increasing module includes at least one logic gate.

20. The system of claim 16 wherein said signal conditioning module includes a termination resistor, a DC blocking capacitor, and a voltage divider.
